(19) United States
(12) Patent Application Publication
(10) Pub. No.: US 2018/0026933 A1
(43) Pub. Date: Jan. 25, 2018

(54) SERVICE AWARE LABEL ADDRESS RESOLUTION PROTOCOL SWITCHED PATH INSTANTIATION

(71) Applicant: Cisco Technology, Inc., San Jose, CA (US)

(72) Inventors: Rajiv Asati, San Jose, CA (US); Nagendra Kumar Nainar, San Jose, CA (US)

(21) Appl. No.: 15/217,799

(22) Filed: Jul. 22, 2016

(51) Int. Cl. H04L 29/12; H04L 29/06; H04L 12/26; H04L 12/733; H04L 29/08; H04L 12/741

(52) U.S. Cl. CPC H04L 61/103; H04L 67/02; H04L 45/74; H04L 43/0829; H04L 45/122; H04L 67/42; H04L 69/22

(57) ABSTRACT

Systems, methods, and computer-readable media for service aware label address resolution or neighbor discovery protocol switched path instantiation for large-scale cloud networks. The system including a gateway server configured to receive from a first client, a request to communicate with a second client, the request including a destination and one or more attributes. The gateway server configured to determine a label based on the destination and the one or more attributes, the label corresponding to a pre-existing tunnel, and transmit a reply to the first client, including the destination, the one or more attributes, and the label.

### TECHNICAL FIELD

The present technology pertains to large-scale cloud networks and more specifically to service aware label address resolution or neighbor discovery protocol switched path instantiation for large-scale cloud networks.

### BACKGROUND

In large scale Cloud and/or Data Center (DC) networks comprising servers (e.g. unified computing system), switches/routers, etc., it is sometimes beneficial for different types of traffic towards the same next-hop prefix (such as that of an egress provider edge forwarder) to take different paths (through the network) based on the certain constraints. For example, delay sensitive traffic to a specific prefix may need a low-latency path, while bandwidth sensitive traffic to the same specific prefix may need a high-bandwidth path. Such scenarios are possible at least in: InterCloud Fabric, Network Function Virtualization (NFV), and Multiprotocol Label Switching (MPLS).

In an InterCloud Fabric, a virtual forwarder of private cloud may be sending different types of traffic (e.g., from different virtual machines having different workloads) towards the remote virtual forwarder of a public (or another private) cloud over the MPLS network.

In an NFV, a virtual forwarder can be serving multiple tenants or service-chains (per tenant) that can be sending different types of traffic to the same set of routers that would then forward the traffic over Wide Area Network (WAN) towards the ultimate destinations.

In a seamless MPLS, an additional problem is that a virtual forwarder would not participate in WAN DC control plane, so it would not be aware of Readable Label Depth (RLD) of each node in the WAN. Given the disjointed routing domains in DC and WAN, the efficacy of entropy label would be limited.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a diagram of an example communication network;

FIG. 2 illustrates a diagram of an example network with pre-established tunnels;

FIGS. 3A and 3B illustrate charts of example routing tables;

FIG. 4 illustrates a flow chart of an example method of service awareness label address resolution protocol transmissions with pre-established tunnels;

FIG. 5 illustrates a diagram of an example network with on-demand tunnels;

FIG. 6 illustrates a flow chart of an example method of service awareness label address resolution protocol transmissions with on-demand tunnels;

FIG. 7 illustrates an example network device; and

FIG. 8A and FIG. 8B illustrate example system embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein can be used to enable service aware label address resolution protocol (L-ARP) in transmissions across networks. A virtual forwarder on a host can send a service aware (e.g., certain attributes) L-ARP request to an adjacent gateway server that can reply with an appropriate label corresponding to the provided attributes. The label maps to a path (e.g., tunnel) across the network that caters to the requested service.

Disclosed are systems, methods, and computer-readable media for service aware label address resolution or neighbor discovery protocol switched path instantiation for large-scale cloud networks. Some embodiments can include a gateway server configured to receive from a first client, a request to communicate with a second client, the request including a destination and one or more attributes. The gateway server configured to determine a label based on the destination and the one or more attributes, the label corresponding to a pre-existing tunnel, and transmit a reply to the first client, including the destination, the one or more attributes, and the label. In some embodiments, the determination can include searching a look-up table, comprising a plurality of labels, based on the destination and the one or more attributes. In some embodiments two or more attributes can be used.

In some embodiments, the request is received from a virtual forwarder executed by the first client executing a plurality of virtual machines and the destination the second client executing a second plurality of virtual machines and a second virtual forwarder.

In some embodiments, the systems, methods, and computer-readable media can determine the label corresponding to the pre-existing tunnel does not exist and can transmit to a path computation element server, the destination and the one or more attributes and can receive from the path computation element server, a new label including a tunnel to the second virtual receiver. The new label can be stored in the look-up table with the destination, the one or more attributes. A reply can be transmitted, to the first client, including the destination, the one or more attributes, and the new label.

In some embodiments, the new label can identify by a path calculation algorithm based on the destination and the one or more attributes. The attributes can selected from the following: bandwidth, differentiated services coded point, latency, L2/L3/L4 header values, number of hops, or packet loss.

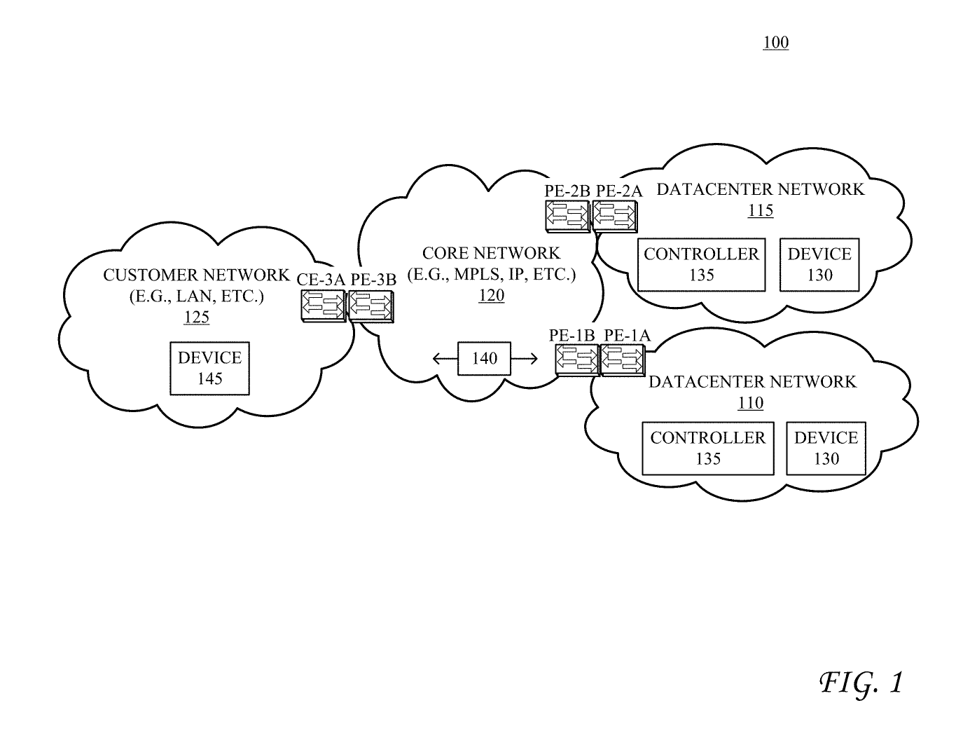

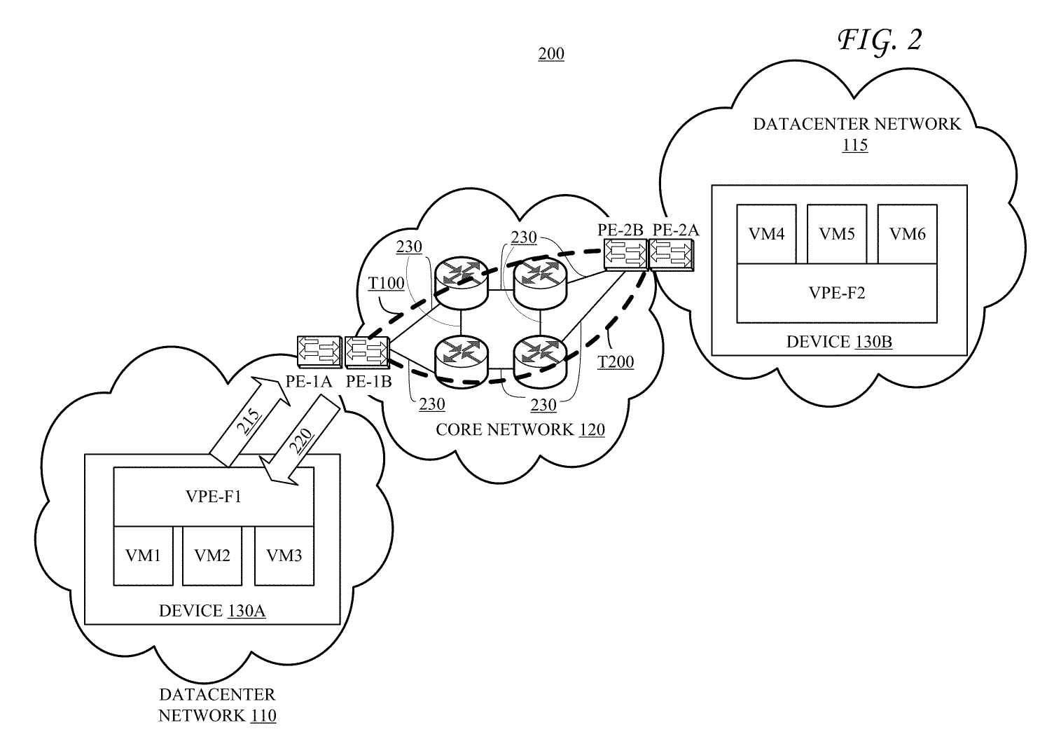

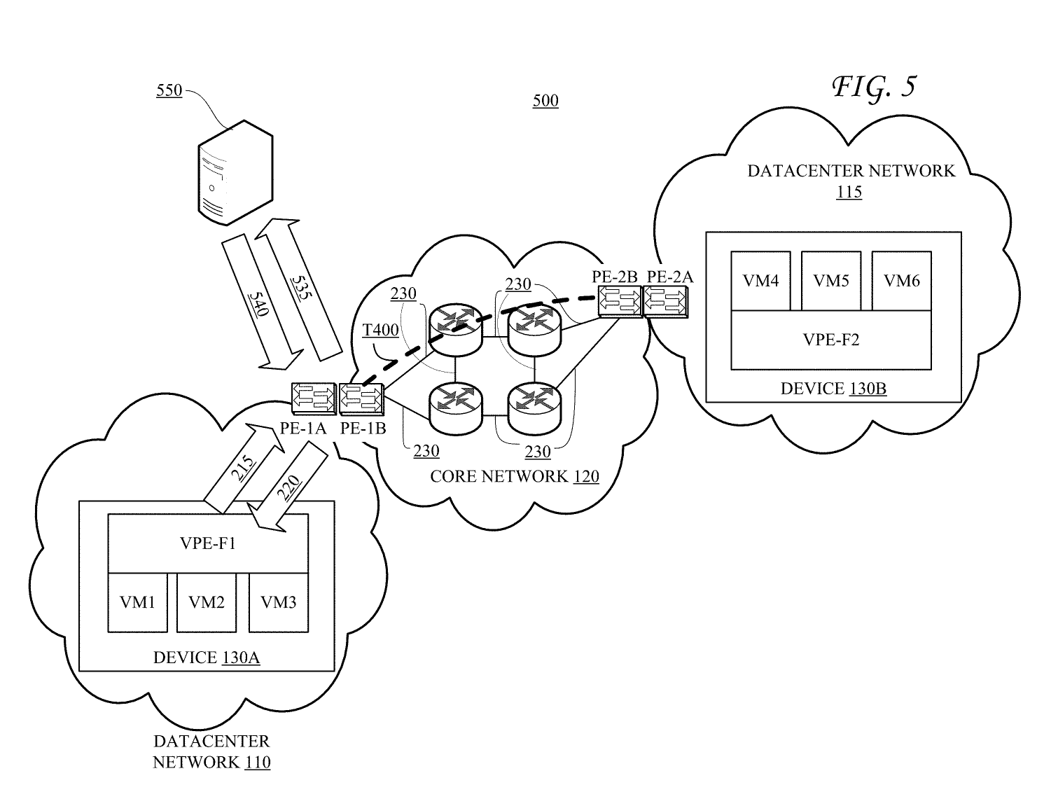

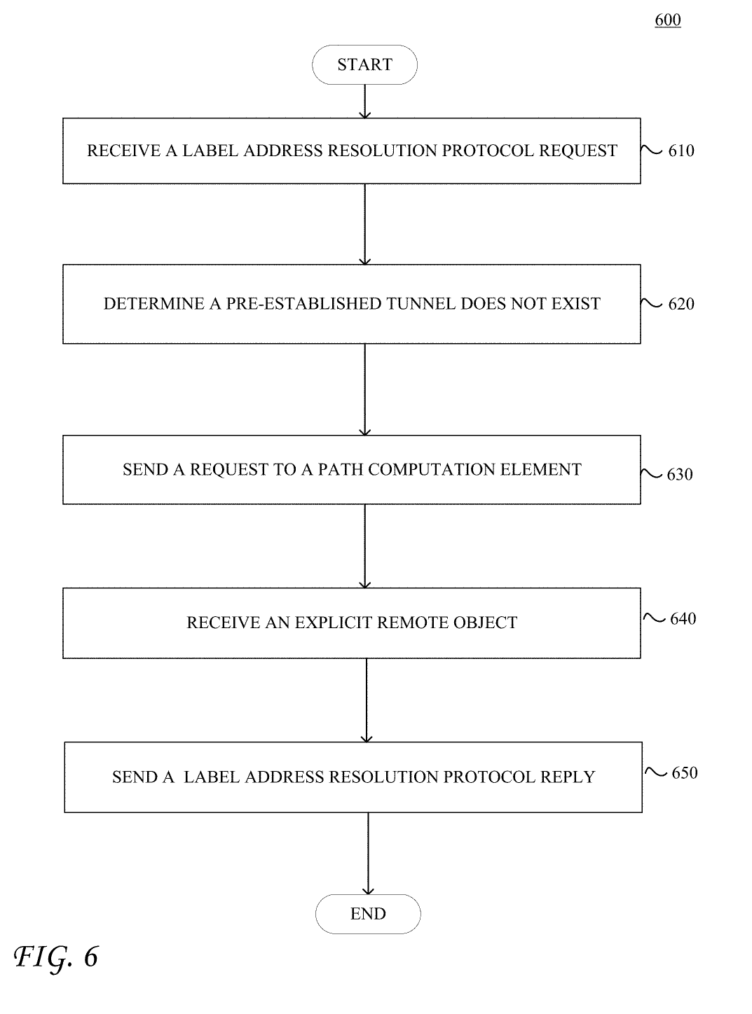

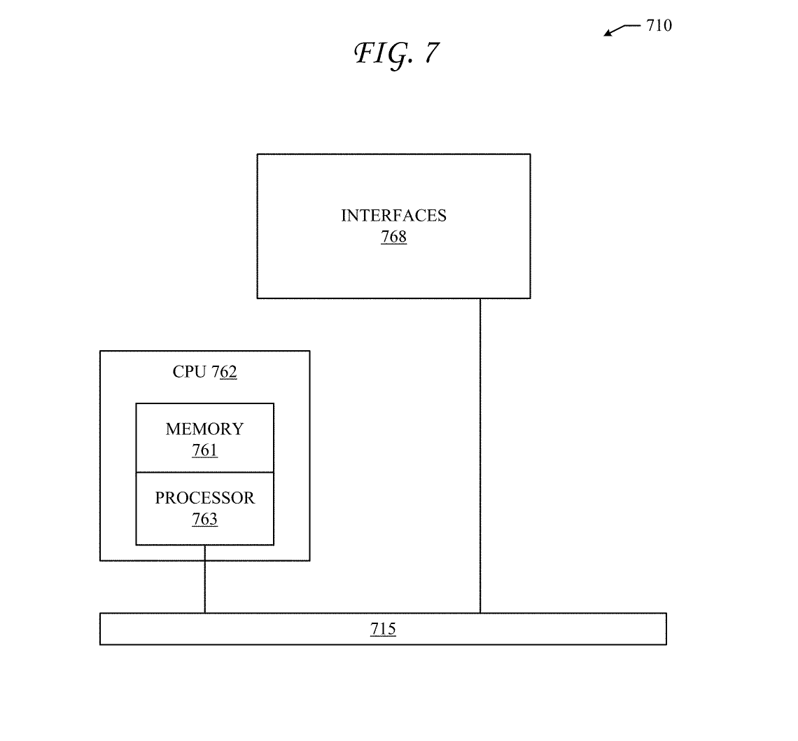

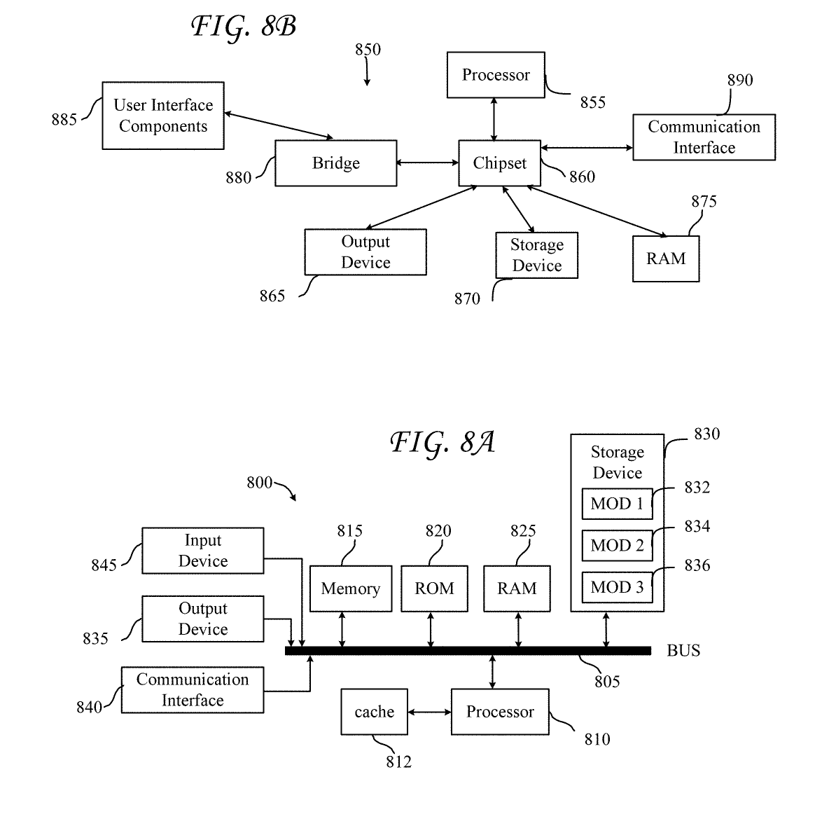

The disclosed technology addresses the need in the art for service aware L-ARP. A description of network computing environments and architectures, as illustrated in FIG. 1, is first disclosed herein. A discussion of pre-established tunnels, as illustrated in FIGS. 2-4, and on-demand tunnels, as illustrated in FIG. 5-6, will then follow. The discussion then concludes with a description of example devices, as illustrated in FIGS. 7 and 8A-B. These variations shall be described herein as the various embodiments are set forth. The disclosure now turns to FIG. 1.

FIG. 1 is a schematic block diagram of an example communication network 100 illustratively including networks 110, 115, 120, and 125. As shown, networks 110, 115 can include one or more virtual and/or physical networks, such as one or more datacenters, local area networks (LANs), virtual local access networks (VLANs), overlay networks, etc. Network 120 can include a core network, such as an IP network and/or a multiprotocol label switching (MPLS) network. In some embodiments, network 120 can be a services provider (SP) network. Customer network 125 can be a client or subscriber network. Moreover, customer network 125 can include one or more networks, such as one or more LANs, for example. Each of networks 110, 115, 120, and 125 can include nodes/devices (e.g., routers, switches, servers, firewalls, gateways, client devices, printers, etc.) interconnected by links, networks, and/or sub-networks. Certain nodes/devices, such as provider edge (PE) devices (e.g., PE-1A,B, PE-2A,B, and PE-3B) and a customer edge (CE) device (e.g., CE-3A), can communicate data such as data packets 140 between networks 110, 115, and 125 via core network 120 (e.g., between device 145, devices 130, and controllers 135 for respective networks).

Data packets 140 can include network flow(s), traffic, frames, and/or messages, for example. Moreover, the data packets 140 can be exchanged among the nodes/devices of communication network 100 over links and networks using network communication protocols, such as Transmission Control Protocol/Internet Protocol (TCP/IP), User Datagram Protocol (UDP), MPLS, VXLAN, etc.

The PE devices (e.g., PE-1A,B, PE-2A,B, and PE-3B) and CE device(s) (e.g., CE-3A) can serve as gateway for respective networks, and can represent an egress and/or ingress point for electronic traffic entering the respective networks. Further, the PE devices (e.g., PE-1A,B, PE-2A,B, and PE-3B) and CE device(s) (e.g., CE-3A) can process, route, treat, and/or manage individual packets. For example, the PE devices (e.g., PE-1A,B, PE-2A,B, and PE-3B) and CE device(s) (e.g., CE-3A) can designate and/or flag individual packets for particular treatment.

Those skilled in the art will understand that any number of nodes, devices, links, networks, topologies, protocols, etc. may be used in the communication network 100, and that the view shown herein is a non-limiting example for explanation purposes. Further, the embodiments described herein may apply to any other network configuration.

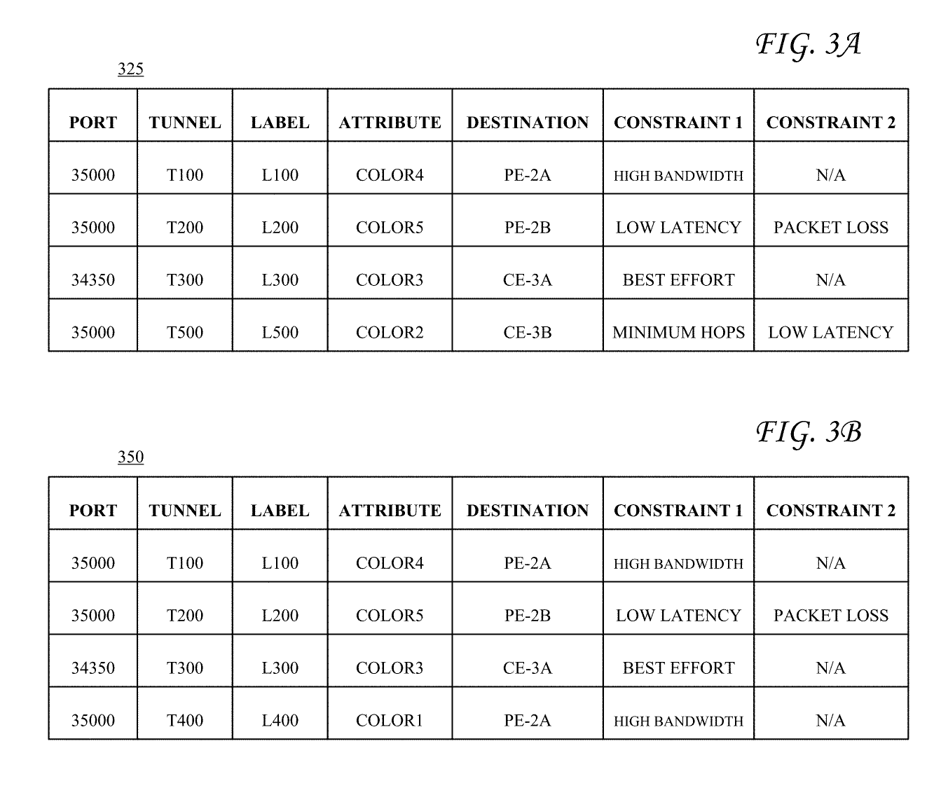

FIG. 2 illustrates an example network with pre-established tunnels 200. In this example, the pre-established tunnels (e.g., T100, T200) are between data center networks (e.g., 110, 115) by core network (e.g., 120). In other examples, the pre-established tunnels (e.g., T100, T200) are between two data center networks. (e.g., 110, 115). In other embodiments, the tunnels can be between a data center network and a customer network (e.g., 125) or two customer networks, or any combination of networks thereof. Devices 130A, 130B can be configured to run a plurality of virtual machines (e.g., VM1, VM2, VM3, VM4, VM5, VM6) and a virtual forwarder (e.g., vPE-F1, vPE-F2). Virtual forwarder (e.g., vPE-F1) of device 130A can send a label address resolution protocol (L-ARP) request 215 to a PE-device (e.g., PE-1A) and receive a L-ARP reply 220 from a PE-device (e.g., PE-1A, B). In other embodiments, label neighbor discover protocol (L-NDP) can be used. The L-ARP request 215 can include a destination (e.g., device 130B, device 145, etc.), and an attribute (e.g., COLOR1, COLOR4, Wildcard, etc.). The L-ARP reply 220 can include the destination, the attribute, and one or more labels (e.g., L100, L200, etc.). The labels can correspond to a selected pre-established tunnel for sending data in accordance with the L-ARP request 215. In some embodiments, multiple attributes can be included in the requests and replies. In some embodiments, the PE-device (e.g., PE-1A) can determine the labels from look-up table 325 (shown in FIG. 3). In other embodiments, the labels can be calculated on-demand (as shown in FIG. 5). The labels (e.g., L100, L200, etc.) in reply 220 can correspond to a pre-existing tunnel to navigate through core network 120 to the destination (e.g., device 130B). Core network 120 can include a plurality of routers (e.g., R1, R2, R3, R3). The plurality of routers can define a plurality of paths 230 to traverse core network 120. Paths 230 can be used to determine different tunnels from one PE device (e.g., PE-1A) to another PE device (e.g., PE-2A).

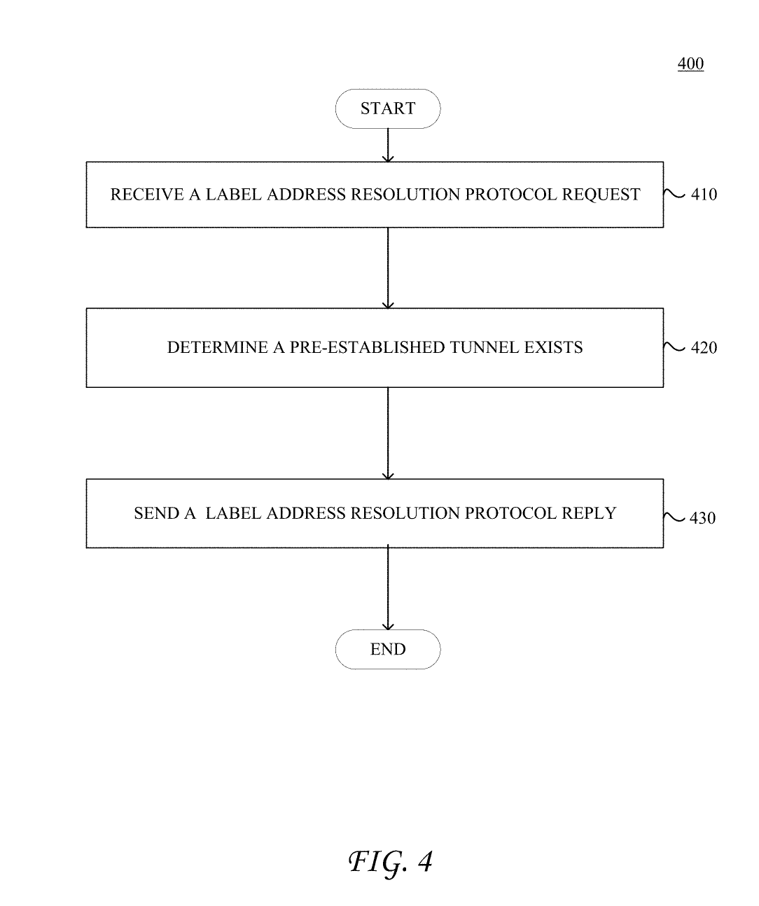

The operation of L-ARP requests and replies using pre-established tunnels is best described using example method 400 of FIG. 4. The method shown in FIG. 4 is provided by way of example, as there are a variety of ways to carry out the method. Additionally, while the example method is illustrated with a particular order of sequences, those of ordinary skill in the art will appreciate that FIG. 4 and the sequences shown therein can be executed in any order that accomplishes the technical advantages of the present disclosure and can include fewer or more sequences than illustrated.

Each sequence shown in FIG. 4 represents one or more processes, methods or subroutines, carried out in the example method. The sequences shown in FIG. 4 can be implemented in a system such as system 200 shown in FIG. 2. The flow chart illustrated in FIG. 4 will be described in relation to and make reference to at least the elements of serving system 200 shown in FIG. 2.

Method 400 can begin at step 410. At step 410, a gateway server (e.g., PE-1A) can receive an L-ARP request 215 (e.g., packet) from a virtual forwarder (e.g., vPE-F1) of device 130A (e.g., server, etc.). For example, VM1 of a plurality of VMs executing on device 130A (e.g., server, etc.) can send to the virtual forwarder (e.g., vPE-F1) a command to communicate with VM4 executing on device 130B (e.g., server, etc.). The virtual forwarder (e.g., vPE-F1) can create and forward a request (e.g., packet) based on the command. The request can include the destination (e.g., device 130B) and one or more attributes or combination of attributes (e.g., COLOR1, COLOR2, COLOR3, COLOR4, COLOR5, etc.).

The one or more attributes can be any attributes of a computer network, for example, bandwidth, differentiated services coded point (DSCP), latency, L2/L3/L4 header values, number of hops, packet loss, etc. In the provided examples, the attributes can be defined by color (e.g., COLOR1, COLOR2, COLOR3, COLOR4, COLOR5, etc.). The colors can include single or multiple attributes that define characteristics of a path from a starting point to an ending point across the network. Accordingly, the colors when used at attributes can define a combination of attributes (e.g., constraints) for data transmission. The colors can be a string defined locally (e.g., on a virtual forwarder, gateway server, etc.) or defined centrally (e.g., centralized server).

At step 420, gateway server (e.g., PE-1A) can determine if a pre-established tunnel (e.g., T100, T200) exists. For example, the gateway server (e.g., PE-1A) can determine whether a pre-established tunnel (e.g., T100, T200) exists by using look-up table 325 (shown in FIG. 3) and based on the attributes received in the request. The pre-established tunnels (e.g., T100, T200) can each correspond to a label (e.g., L100, L200). When an attribute (e.g., COLOR5) is received, the gateway server (e.g., PE-1A) can determine that a pre-established tunnel (e.g., T100) exists. The pre-established tunnel (e.g., T100) can route data from device 130A through core network 120 to device 130B based on the constraints (e.g., high bandwidth). For example, tunnel T100 can be a high bandwidth tunnel through PE-1A, R1, R2, and PE-2A connecting devices 130A and 130B. In another example, tunnel 200 can be a low latency tunnel through PE-1A, R3, R4, and PE-2A. The pre-established tunnels can be created and stored based on the attributes that define the tunnels (e.g., COLOR1, COLOR2, COLOR3, COLOR4, COLOR5, etc.).

At step 430, gateway server (e.g., PE-1A) can send to virtual forwarder (e.g., vPE-F1) executing on device 130A, a L-ARP reply 220 (e.g., packet). For example, L-ARP reply (e.g., 220) can include the destination (e.g., PE-2A), one or more attributes (e.g., COLOR4, etc.) and a label (e.g., L100) corresponding to a pre-established tunnel (e.g., T100). In response to receiving the L-ARP reply 220, the virtual forwarder (e.g., vPE-F1) can send data to remote gateway server (e.g., PE-2A) by the pre-established tunnel (e.g., T100) by utilizing the label (e.g., L100). For example, the virtual forwarder (e.g., vPE-F1) can send data with an attribute equal to the label (e.g., L100) to instruct the gateway server (e.g., PE-1A) to send the data to the remote gateway server (e.g., PE-2A) by the pre-established tunnel (e.g., T100) that corresponds to the label (e.g., L100) specified in the data.

FIG. 5 illustrates a diagram of an example network with on-demand tunnels 500. As previously shown in FIG. 2, the gateway server (e.g., PE-1A) can receive a L-ARP request 215 from the virtual forwarder (e.g., vPE-F1) of device 130A. When the gateway server (e.g., PE-1A) cannot locate, in look-up table 325, a pre-established tunnel (e.g., T100, T200, etc.) corresponding to the attributes specified in the request, the gateway server (e.g., PE-1A) can determine an on-demand path for communication to the destination (e.g., device 130B). The gateway server (e.g., PE-1A), in response to not locating a pre-established tunnel, can send a PCE protocol request (e.g., 535) to path computation element (PCE) 550. The PCE request (e.g., 535) sent to PCE 550 can include, the destination, one or more attributes (e.g., COLOR4, COLOR5, etc.) and a transport port (e.g., port 35000 in TCP, port 34350 in UDP, etc.). In some embodiments, the transport port is included in the original request from the virtual forwarder (e.g., vPE-F1).

In response to receiving the request, PCE 550 can run a path computation to determine an explicit route object (ERO). In other embodiments, the ERO can be determined at the gateway server (e.g., PE-1A). The path computation can take into consideration, the transport port, the one or more attributes, and the destination to determine the ERO. In some embodiments PCE 550 can determine more than one ERO based on the received PCE protocol request and the attributes. Upon determining the ERO, the PCE 550 can send to the gateway server (e.g., PE-1A) the ERO through PCE reply (e.g., 540).

When the gateway server (e.g., PE-1A) receives the ERO from PCE 550, the gateway server can setup the path T400 (e.g., Resource Reservation Protocol-Traffic Engineering Label Switched Paths (RSVP-TE LSP) or Segment Routing TE LSP), and assign a local label (e.g., L400). The local label (e.g., L400) can be stored in the look-up table (e.g., 350 shown in FIG. 3B). Once the label (e.g., L400) is stored in the look-up table (e.g., 325, 350), the label then corresponds to a pre-established path (e.g., T400). The gateway server (e.g., PE-1A) can then send an L-ARP reply 220 to virtual forwarder (e.g., vPE-F1) including the local label (e.g., L400).

The operation of L-ARP requests and replies using on-demand tunnels is best described using an example, method 600 of FIG. 6. The method shown in FIG. 6 is provided by way of example, as there are a variety of ways to carry out the method. Additionally, while the example method is illustrated with a particular order of sequences, those of ordinary skill in the art will appreciate that FIG. 6 and the sequences shown therein can be executed in any order that accomplishes the technical advantages of the present disclosure and can include fewer or more sequences than illustrated.

Each sequence shown in FIG. 6 represents one or more processes, methods or subroutines, carried out in the example method. The sequences shown in FIG. 6 can be implemented in a system such as system 500 shown in FIG. 5. The flow chart illustrated in FIG. 6 will be described in relation to and make reference to at least the elements of serving system 500 shown in FIG. 5.

Method 600 can begin at step 610. At step 610, a gateway server (e.g., PE-1A) can receive an L-ARP request 215 (e.g., packet) from a virtual forwarder (e.g., vPE-F1) of device 130A (e.g., server, etc.). For example, VM1 of a plurality of VMs executing on device 130A (e.g., server, etc.) can send to the virtual forwarder (e.g., vPE-F1) a command to communicate with VM4 executing on device 130B (e.g., server, etc.). The virtual forwarder (e.g., vPE-F1) can create and forward a request (e.g., packet) based on the command. The request can include the destination (e.g., device 130B), one or more attributes or combination of attributes (e.g., COLOR1, COLOR2, COLOR3, COLOR4, COLOR5, etc.), and a port (e.g., port 35000 in TCP, port 34350 in UDP, etc.).

At step 620, gateway server (e.g., PE-1A) can determine that a pre-established tunnel does not exist. For example, the gateway server (e.g., PE-1A) can determine that a pre-established tunnel does not exists by using look-up table 325 (shown in FIG. 3) and based on the attributes received in the request.

At step 630, gateway server (e.g., PE-1A) can send to a PCE (e.g., 550) a PCE protocol (PCEP) request 535. For example, the PCEP request 535 can include the destination, the attributes, and the port. In response to receiving the PCEP request 535, PCE 550 can determine an ERO. That is, PCE 550 can determine an ERO that meets the received criteria from the PCEP request 535 (e.g., port 35000 and a high bandwidth path) and network topology information (e.g., R1, R2, R3, R4, etc.).

At step 640, gateway server (e.g., PE-1A) can receive the ERO from the PCE (e.g., 550) in a PCEP reply 540. In response to receiving the ERO, gateway server (e.g., PE-1A) can instantiate a path (e.g., T400) through the network (e.g., core network 120), create a label (e.g., T400) for the path, and store the path (e.g., T400) and the associate data (e.g., attributes, label, etc.) in the look-up table (e.g., 350).

At step 650, the gateway server (e.g., PE-1A) can send to the virtual forwarder (e.g., vPE-F1) executing on device 130A, a L-ARP reply 220 (e.g., packet). For example, L-ARP reply (e.g., 220) can include destination (e.g., PE-2A), one or more attributes (e.g., COLOR4, COLOR5, COLOR1, etc.) and a label (e.g., L400) corresponding to the on-demand tunnel (e.g., T400). In response to receiving the L-ARP reply 220, the virtual forwarder (e.g., vPE-F1) can send data to a remote gateway server (e.g., PE-2A) by the on-demand tunnel (e.g., T400) by utilizing the label (e.g., L400). For example, the virtual forwarder (e.g., vPE-F1) can send data with an attribute equal to the label (e.g., L400) to instruct the gateway server (e.g., PE-1A) to send the data to the remote gateway server (e.g., PE-2A) by the on-demand tunnel (e.g., T400) that corresponds to the label (e.g., L400).

The disclosure now turns to the example network device and system illustrated in FIG. 7. FIG. 7 illustrates an example network device 710 suitable for routing, switching, forwarding, traffic management, and load balancing. Network device 710 can be, for example, a router, a switch, a controller, a server, a gateway, and/or any other L2 and/or L3 device.

Network device 710 can include a master central processing unit (CPU) 762, interfaces 768, and a bus 715 (e.g., a PCI bus). When acting under the control of appropriate software or firmware, the CPU 762 is responsible for executing packet management, error detection, load balancing operations, and/or routing functions. The CPU 762 can accomplish all these functions under the control of software including an operating system and any appropriate applications software. CPU 762 may include one or more processors 763, such as a processor from the Motorola family of microprocessors or the MIPS family of microprocessors. In an alternative embodiment, processor 763 is specially designed hardware for controlling the operations of network device 710. In a specific embodiment, a memory 761 (such as non-volatile RAM and/or ROM) also forms part of CPU 762. However, there are many different ways in which memory could be coupled to the system.

The interfaces 768 are typically provided as interface cards (sometimes referred to as “line cards”). Generally, they control the sending and receiving of data packets over the network and sometimes support other peripherals used with the network device 710. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 762 to efficiently perform routing computations, network diagnostics, security functions, etc.

Although the system shown in FIG. 7 is one specific network device of the present invention, it is by no means the only network device architecture on which the present invention can be implemented. For example, an architecture having a single processor that handles communications as well as routing computations, etc. is often used. Further, other types of interfaces and media could also be used with the router.

Regardless of the network device's configuration, it may employ one or more memories or memory modules (including memory 761) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc.

FIG. 8A and FIG. 8B illustrate example system embodiments. The more appropriate embodiment will be apparent to those of ordinary skill in the art when practicing the present technology. Persons of ordinary skill in the art will also readily appreciate that other system embodiments are possible.

FIG. 8A illustrates a conventional system bus computing system architecture 800 wherein the components of the system are in electrical communication with each other using a bus 805. Exemplary system 800 includes a processing unit (CPU or processor) 810 and a system bus 805 that couples various system components including the system memory 815, such as read only memory (ROM) 820 and random access memory (RAM) 825, to the processor 810. The system 800 can include a cache of high-speed memory connected directly with, in close proximity to, or integrated as part of the processor 810. The system 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other system memory 815 may be available for use as well. The memory 815 can include multiple different types of memory with different performance characteristics. The processor 810 can include any general purpose processor and a hardware module or software module, such as module 1 832, module 2 834, and module 3 836 stored in storage device 830, configured to control the processor 810 as well as a special-purpose processor where software instructions are incorporated into the actual processor design. The processor 810 may essentially be a completely self-contained computing system, containing multiple cores or processors, a bus, memory controller, cache, etc. A multi-core processor may be symmetric or asymmetric.

To enable user interaction with the computing device 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art. In some instances, multimodal systems can enable a user to provide multiple types of input to communicate with the computing device 800. The communications interface 840 can generally govern and manage the user input and system output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof.

The storage device 830 can include software modules 832, 834, 836 for controlling the processor 810. Other hardware or software modules are contemplated. The storage device 830 can be connected to the system bus 805. In one aspect, a hardware module that performs a particular function can include the software component stored in a computer-readable medium in connection with the necessary hardware components, such as the processor 810, bus 805, display 835, and so forth, to carry out the function.

FIG. 8B illustrates an example computer system 850 having a chipset architecture that can be used in executing the described method and generating and displaying a graphical user interface (GUI). Computer system 850 is an example of computer hardware, software, and firmware that can be used to implement the disclosed technology. System 850 can include a processor 855, representative of any number of physically and/or logically distinct resources capable of executing software, firmware, and hardware configured to perform identified computations. Processor 855 can communicate with a chipset 860 that can control input to and output from processor 855. In this example, chipset 860 outputs information to output device 865, such as a display, and can read and write information to storage device 890, which can include magnetic media, and solid state media, for example. Chipset 860 can also read data from and write data to RAM 875. A bridge 880 for interfacing with a variety of user interface components 885 can be provided for interfacing with chipset 860. Such user interface components 885 can include a keyboard, a microphone, touch detection and processing circuitry, a pointing device, such as a mouse, and so on. In general, inputs to system 850 can come from any of a variety of sources, machine generated and/or human generated.

Chipset 860 can also interface with one or more communication interfaces 890 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 855 analyzing data stored in storage 870 or 875. Further, the machine can receive inputs from a user via user interface components 885 and execute appropriate functions, such as browsing functions by interpreting these inputs using processor 855.

It can be appreciated that example systems 800 and 850 can have more than one processor 810 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

What is claimed is:

1. A computer-implemented method comprising:
receiving, at a gateway server from a first client, a request to communicate with a second client, the request including a destination and one or more attributes;
determining a label based on the destination and the one or more attributes, the label corresponding to a pre-existing tunnel; and
transmitting a reply, to the first client, including the destination, the one or more attributes, and the label.

2. The method of claim 1, wherein the request is received from a virtual forwarder executed by the first client executing a plurality of virtual machines.

3. The method of claim 1, wherein the destination is the second client executing a second plurality of virtual machines and a second virtual forwarder.

4. The method of claim 1, wherein the determining further comprising:
a look-up table, comprising a plurality of labels, based on the destination and the one or more attributes.

5. The method of claim 1, further comprising:
determining the label corresponding to the pre-existing tunnel does not exist;
transmitting, to a path computation element server, the destination and the one or more attributes;
receiving, from the path computation element server, a new label including a tunnel to the second client;
storing, in a look-up table, the destination, the one or more attributes, and the new label; and
transmitting, to the first client, a reply including the destination, the one or more attributes, and the new label.

6. The method of claim 5, wherein the new label is identified by a path calculation algorithm based on the destination and the one or more attributes.

7. The method of claim 1, wherein the attributes are selected from two of the following: bandwidth, differentiated services coded point, latency, L2/L3/L4 header values, number of hops, or packet loss.

8. A provider edge device comprising:
a processor; and
a computer-readable storage medium having stored therein instructions which, when executed by the processor, cause the processor to:
receive from a first client, a request to communicate with a second client, the request including a destination and one or more attributes;
determine a label based on the destination and the one or more attributes, the label corresponding to a pre-existing tunnel; and
transmit a reply to the first client, including the destination, the one or more attributes, and the label.

9. The provider edge device of claim 8, wherein the request is received from a virtual forwarder executed by the first client executing a plurality of virtual machines.

10. The provider edge device of claim 8, wherein the destination is the second client executing a second plurality of virtual machines and a second virtual forwarder.

11. The provider edge device of claim 8, wherein the determination further causing the processor to:
search a look-up table, comprising a plurality of labels, based on the destination and the one or more attributes.

12. The provider edge device of claim 8, comprising further instructions which, when executed by the processor, cause the processor to:
determine the label corresponding to the pre-existing tunnel does not exist;
transmit, to a path computation element server, the destination and the one or more attributes;
receive, from the path computation element server, a new label including a tunnel to the second client;
store, in a look-up table, the destination, the one or more attributes, and the new label; and
transmit, to the first client, a reply including the destination, the one or more attributes, and the new label.

13. The provider edge device of claim 12, wherein the new label is identified by a path calculation algorithm based on the destination and the one or more attributes.

14. The provider edge device of claim 8, wherein the attributes are selected from two of the following: bandwidth, differentiated services coded point, latency, L2/L3/L4 header values, number of hops, or packet loss.

15. A non-transitory computer-readable storage medium having stored therein instructions which, when executed by a processor, cause the processor to:
receive from a first client, a request to communicate with a second client, the request including a destination and one or more attributes;
determine a label based on the destination and the one or more attributes, the label corresponding to a pre-existing tunnel; and
transmit a reply to the first client, including the destination, the one or more attributes, and the label.

16. The non-transitory computer-readable storage medium of claim 15, wherein the request is received from a virtual forwarder executed by the first client executing a plurality of virtual machines.

17. The non-transitory computer-readable storage medium of claim 15, wherein the determination further causing the processor to:
search a look-up table, comprising a plurality of labels, based on the destination and the one or more attributes.

18. The non-transitory computer-readable storage medium of claim 15, comprising further instructions which, when executed by the processor, cause the processor to:
determine the label corresponding to the pre-existing tunnel does not exist;
transmit, to a path computation element server, the destination and the one or more attributes;
receive, from the path computation element server, a new label including a tunnel to the second client;
store, in a look-up table, the destination, the one or more attributes, and the new label; and
transmit, to the first client, a reply including the destination, the one or more attributes, and the new label.

19. The non-transitory computer-readable storage medium of claim 18, wherein the new label is identified by a path calculation algorithm based on the destination and the one or more attributes.

20. The non-transitory computer-readable storage medium of claim 15, wherein the attributes are selected from two of the following: bandwidth, differentiated services coded point, latency, L2/L3/L4 header values, number of hops, or packet loss.
